(19) United States
(12) Patent Application Publication
(10) Pub. No.: US 2020/0296179 A1
(43) Pub. Date: Sep. 17, 2020

(54) System, Method, and Apparatus for Remote Computer Command Execution

(71) Applicant: P. C Pitstop, Inc., Sioux City, IA (US)

(72) Inventor: Andrew Tuch, Boca Raton, FL (US)

(73) Assignee: P.C. Pitstop, Inc., SIOUX CITY, IA (US)

(21) Appl. No.: 16/355,757

(22) Filed: Mar. 17, 2019

(51) Int. Cl. H04L 29/08; H04L 29/06; G06F 21/62; G06F 9/451

(52) U.S. Cl. CPC H04L 67/26; H04L 63/20; G06F 9/452; H04L 63/10; G06F 21/629

(57) ABSTRACT

A system, method, and apparatus for executing a command on a remote computer includes installing a push controller module on an end-point device. Upon initialization of the end-point device, the push controller module begins running and establishes a connection to a push server. Upon receiving the command for the end-point device, the push server forwards the command to the push controller module that is running on the end-point device and responsive to receiving the command, the push controller module executes the command.

### FIELD

This invention relates to computer security and more particularly to a system for performing remote operations on a processor-based device.

### BACKGROUND

Currently, many information technology (IT) professionals need to check status and make changes to a myriad of processor-based devices (desktop computers, notebook computers, tablets, smartphones, smartwatches, etc.). Often, these IT professionals are responsible for hundreds or thousands of such processor-based devices, many of which are located in geographically disperse locations, in offices, user's homes, satellite offices, vehicles, etc.

Today, to make a minor change on these processor-based devices, the IT professional has several options. The first is to visit each processor-based device and perform the operation. Such is often a horrendous task just to keep track of which device was updated and arranging time with the users of each device to visit their home/office to make the change.

A second way to make such changes is to call each user and have each user enter commands as the IT professional would enter such commands. Again, with hundreds or thousands of such devices, this is a daunting task, but further complicated by the ability of each user to understand what the IT person is asking and execute correctly, adding time for the usual niceties. Further, extra time is required for each user, as it is much quicker for the IT professional to perform the task than it is to explain to each user what needs to be done, etc. Further, there is no positive confirmation that the task was completed correctly.

A third way to make such changes is to remotely operate each computer as done today with remote control software that provides access to the user's computer. This requires the IT professional to contact each user, have that user visit a web site and agree to have their computer controlled by the IT professional, and then the IT professional can operate the device as if they were at the keyboard/mouse and display. The advantage to the third way is that the IT professional need not travel to each user's location.

There are major disadvantages shared by all of the existing methods cited. The first is the amount of time required for the IT professional to enact even minor changes such as registry edits (REGEDIT). The second is the intrusion into the user's time and schedule, as the user is impacted by meeting with the IT professional, distraction from their normal operation, and time spent while the IT professional performs the operation.

Therefore, a non-intrusive mechanism for remotely executing commands is needed.

### SUMMARY

In one embodiment, a system for remote computer command execution includes a push server and a plurality of end-point device. A push controller module that is installed on each of the end-point devices initializes upon start-up of each of the end-point devices and each push controller module automatically establishing a connection to the push server. Upon receiving a command for execution on one of the end-point devices from a web portal computer, the push server forwards the command to the push controller module of that end-point device over a respective connection. Upon receiving the command, the push controller module executes the command on the end-point device, captures output from the command, and forwards the output to the push server. Upon receiving the output from the push controller module, the push server forwards the output to the web portal computer. In some such embodiments, two or more web portal computers independently forward commands to the push controller module of that end-point device over a respective connection. Upon receiving the commands, the push controller module executes the commands on the end-point device, captures output from the command, and forwards the output to the push server. Upon receiving the output from the push controller module, the push server forwards the output to the web portal computer that issued the command. For example, a first IT person at a first web portal computer is viewing the device page of an end-point device while a second IT person at a second web portal computer is viewing a device listing page of the same end-point device. The command output(s) are delivered to both IT person's browsers at their web portal computer, even if they are not in the same location.

In some embodiments, the push server directs output from one push controller module to multiple web portal computers (e.g. for performance monitoring of the end-point device).

In another embodiment, a method of executing a command on a remote computer includes installing a push controller module on an end-point device. Upon initialization of the end-point device, the push controller module begins running and establishes a connection to a push server. Upon receiving the command for the end-point device, the push server forwards the command to the push controller module that is running on the end-point device and responsive to receiving the command, the push controller module executes the command.

In another embodiment, program instructions are tangibly embodied in a non-transitory storage medium comprising at least one instruction configured to implement a system for executing a command on a remote computer. At least one computer readable instruction executed by a processor of an end-point device causes the end-point device to initiate a connection to a push server. Computer readable instructions executed by a processor of the push server accept the connection. Computer readable instructions executed by the processor of the push server receive the command for the end-point device and responsive to the computer readable instructions executed by the processor of the push server receiving the command, the computer readable instructions executed by the processor of the push server forward the command to the computer readable instructions executed by the processor of the end-point device and responsive to receiving the command, the computer readable instructions executed by the processor of the end-point device causing the end-point device to execute the command.

### BRIEF DESCRIPTION OF THE DRAWINGS

The invention can be best understood by those having ordinary skill in the art, by referencing the following detailed description when considering the accompanying drawings, in which:

FIG. 1 illustrates a data connection diagram of the system for remote computer command execution.

FIG. 2 illustrates a schematic view of a typical end-point device controlled by the system for remote computer command execution.

FIG. 3 illustrates a schematic view of a typical server computer system.

FIG. 4 illustrates a computer user interface of the system for remote computer command execution.

FIG. 5 illustrates an exemplary program flow of the push controller module of the system for remote computer command execution.

FIG. 6 illustrates an exemplary push database of the system for remote computer command execution.

FIG. 7 illustrates an exemplary program flow of the push server of the system for remote computer command execution.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the system for remote computer command execution has a remote end-point control system that provides for executing commands and receiving responses at one or more end-point devices without interruption of the users of the end-point devices. Each end-point device is connected to a secure push server onto which the IT professional logs into for transmission of commands and reception of responses. There is no restriction on the number or type of end-point device which is anticipated to b, but not restricted to, any combination of desktop computers, notebook computers, tablets, smartphones, smartwatches, etc.

Throughout this description, the term, “computer” refers to any system that has a processor and runs software. One example of such is a personal computer. The term, “user” refers to a human that has an interest in the computer, perhaps a user who is using the computer.

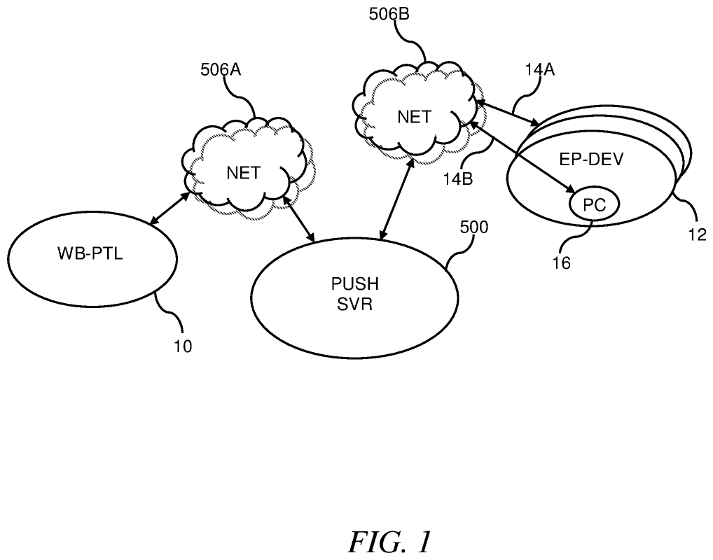

Referring to FIG. 1 illustrates a data connection diagram of the exemplary system for remote computer command execution. In this example, a web portal computer 10 (e.g., a personal computer) communicates through a first network 506A (e.g. the Internet, local area network, etc.) to a push server 500.

The push server 500 provides access security, allowing only those authorized to access the push server 500, and therefore, to execute commands on the end-point device 12.

Although one path between the web portal computer 10 and the push server 500 is through the network 506A as shown, any known data path is anticipated. For example, Wi-Fi combined with a wide area network, which includes the Internet.

The push server 500 transacts with software running on the web portal computer 10 (or any computing device) through the network(s) 506. The software provides security and mechanisms to effect transmission of commands to the end-point device 12 and reception of response from the end-point devices 12.

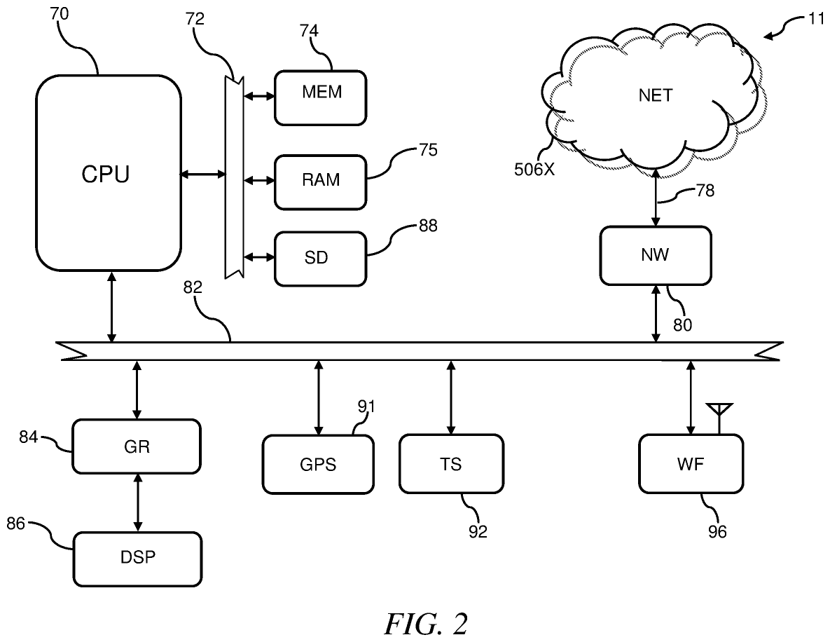

Referring to FIG. 2, a schematic view of an exemplary device 11 used as a web portal computer 10 or end-point device 12 is shown. The exemplary device 11 is a processor-based device for providing end-to-end operation of the system for remote computer command execution. The present invention is in no way limited to any particular device, often known as a personal computer. Many other processor-based devices are equally anticipated including, but not limited to smart phones, cellular phones, portable digital assistants, routers, thermostats, fitness devices, etc.

The exemplary device 11 represents a typical device used by the system for remote computer command execution. This exemplary device 11 is shown in its simplest form. Different architectures are known that accomplish similar results in a similar fashion, and the present invention is not limited in any way to any particular system architecture or implementation. In this exemplary device 11, a processor 70 executes or runs programs in a random access memory 75. The programs are generally stored within a persistent memory 74 and loaded into the random access memory 75 when needed. In some devices 11, a removable storage slot 88 (e.g., compact flash, SD) offers removable persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary devices 11, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceivers 96, touch screen interfaces 92, image sensors, temperature sensors, etc., the details of which are not shown for brevity and clarity reasons.

The network interface 80 connects the exemplary device 11 to the network 506X (e.g. first network 506A or second network 506B) through any known or future protocol such as Ethernet, WI-FI, GSM, TDMA, LTE, etc., through a wired or wireless medium 78. There is no limitation on the type of connection used. The network interface 80 provides data and messaging connections between the exemplary device 11 and the server through the network 506X (e.g. first network 506A or second network 506B). Note, in some embodiments, the first network 506A is the same or overlaps with the second network 506B.

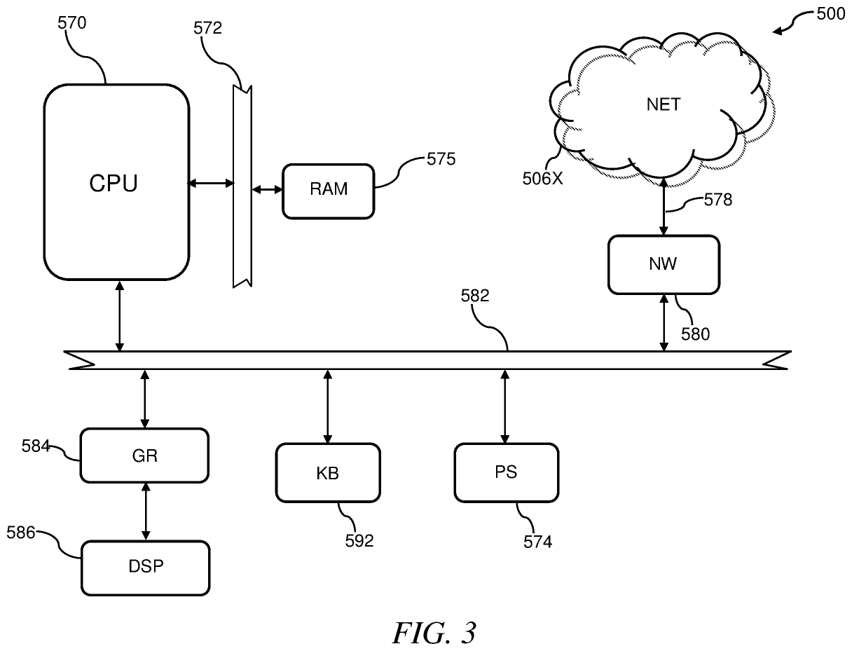

Referring to FIG. 3, a schematic view of a typical push server system (e.g., push server 500) is shown. The example push server 500 represents a typical server computer system used as in the system for remote computer command execution. This exemplary push server 500 is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a network 506X—e.g. first network 506A and/or second network 506B), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

Referring back to FIG. 1, two connections 14A/14B are shown, though as previously stated, any number of end-point devices 12, hence connections 14A/14B are anticipated. Each of the connections 14A/14B is between the push server 500 and a push controller module 16 that runs on each end-point device 12. Upon initialization (e.g. boot) of each end-point device 12, a software program called a push controller module 16 (PC) runs and the push controller module 16 initializes and connects to the push server 500, for example through, for example, a web socket connection. In such, as the push controller module 16 initiates the connection, it is difficult to hack into the end-point devices 12, as the end-point devices 12 are not accepting connections from an external server, the end-point device 12 are initiating connections to on such server, the push server 500.

The push server 500 having connections to one or many end-point devices 12 provides an environment to each web portal computer 10 to accept commands from the web portal computer 10 and route the commands over the connections 14A/14B to one or more push controller modules 16 running on one or more end-point devices 12. Each push controller module 16 attempts to execute the command and captures the standard output and standard error streams (or equivalent) and forwards the standard output and standard error streams back to the push server 500 through the connections 14A/14B back to the push server 500 and, hence, back to the web portal computer 10 that initiated the command execution.

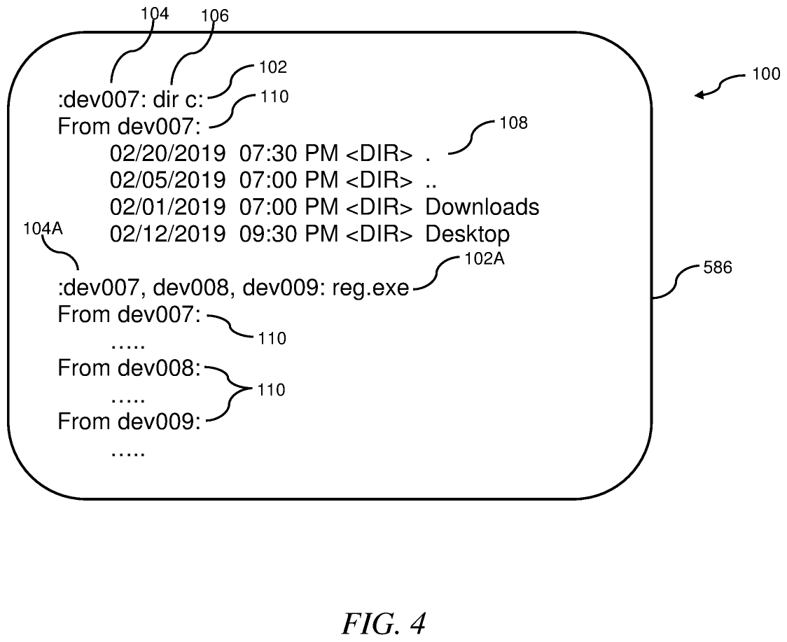

Referring to FIG. 4, an exemplary user interfaces 100 of the web portal computer 10 is shown. Although many user interfaces are anticipated, one is shown for brevity reasons. The user interface 100 has a command prompt (“:”) indicating that the web portal computer 10 is ready to accept a command for one or more of the end-point devices 12. The technician enters a command line 102 at the web portal computer 10, including a logical address 104 (or name) of the end-point device 12 and a command 106 that is to be run by the end-point device 12. In this example, the command 106 is “dir c:” which requests a listing of files and folders in the root directory of a storage device of the end-point device 12 referred to as the logical address 104 (or name).

The logical address 104 and the command 106 are forwarded to the push server 500 and the push server 500 translates the logical address 104 into a connection handle for a connection 14A/14B that has already been established between the end-point device 12 and the push server 500. As many computers have the same computer name, the logical address 104 is a computer identifier (CID) to which the IT person will refer to when addressing a specific end-point device 12.

The push server 500 then sends the command 106 to the push controller module 16 running on the targeted end-point device 12 over the associated connection 14A/14B. Upon receipt of the command 106, the push controller module 16 running on the targeted end-point device 12 executes the command 106, capturing standard output and standard error streams 108 from the execution of the command 106. The push controller module 16 sends any output from the standard output and standard error streams 108 back to the push server 500 over the associated connection 14A/14B. The push server 500 forwards the output from the standard output and standard error streams 108 back to the web portal computer 10 where the standard output and standard error streams 108 are displayed.

In some embodiments, a multiple destination command 102A is entered in which the logical address 104A includes multiple logical addresses, in this example, three logical addresses—dev007, dev008, and dev009. In this example, the multiple destination command 102A is individually forwarded to each end-point device 12 through associated connections 14A/14B in the same fashion as described above. Note that when the standard output and standard error streams 108 are displayed, a heading indicates the logical address 104 from which the standard output and standard error streams 108 came. Therefore, after the multiple destination command 102A is executed, multiple standard output and standard error streams 108 are displayed, each having a heading that indicates the logical address 104 from which the standard output and standard error streams 108 came.

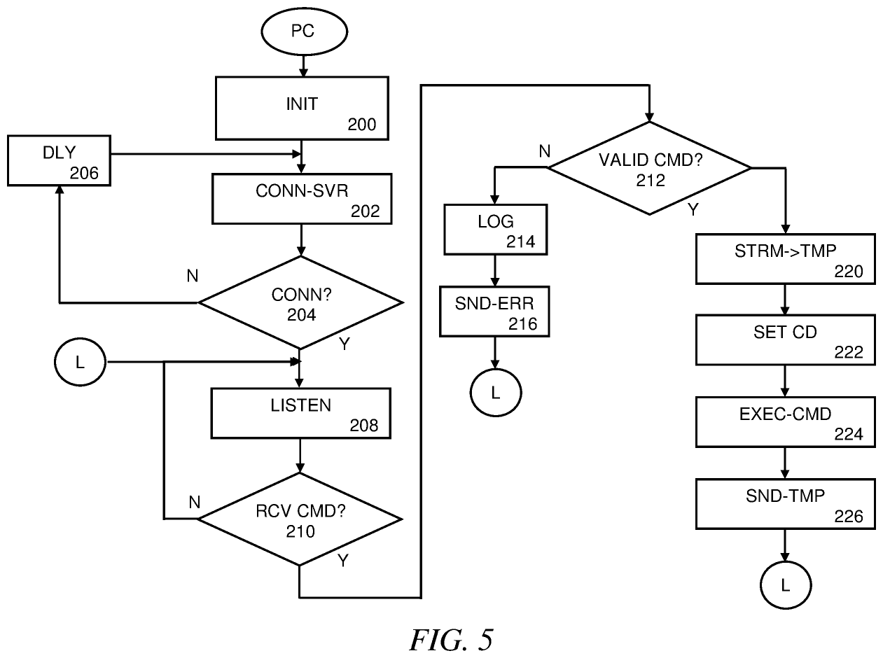

Referring to FIG. 5, an exemplary program flow of the push controller module 16 is shown. It is anticipated that portions of the exemplary program flow execute on web portal computer 10, the push server, and/or the end-point device 12.

During system initialization of the end-point device 12, the push controller module 16 initializes 200 then attempts to connect 202 to the push server 500. If the connection fails 204, a delay is taken 206 and the above steps 202/204 are repeated.

Once the connection succeeds 204, a loop starts, periodically (or by interrupt) the push controller module 16 listening 208 for an incoming command, checking 210 if a command 106 was received from the push server 500. For example, the push controller module 16 listens for a message from the push server 500 and then executes the command. Once a command 106 is received from the push server 500, optionally, a test 212 is made to determine if it is a valid command, for example, checking the command 106 against a list of commands 106 that are approved for remote execution. If the test 212 determines that the command 106 is not a valid command, the attempt is logged 214 and an error indication is sent 216 back to the push server 500.

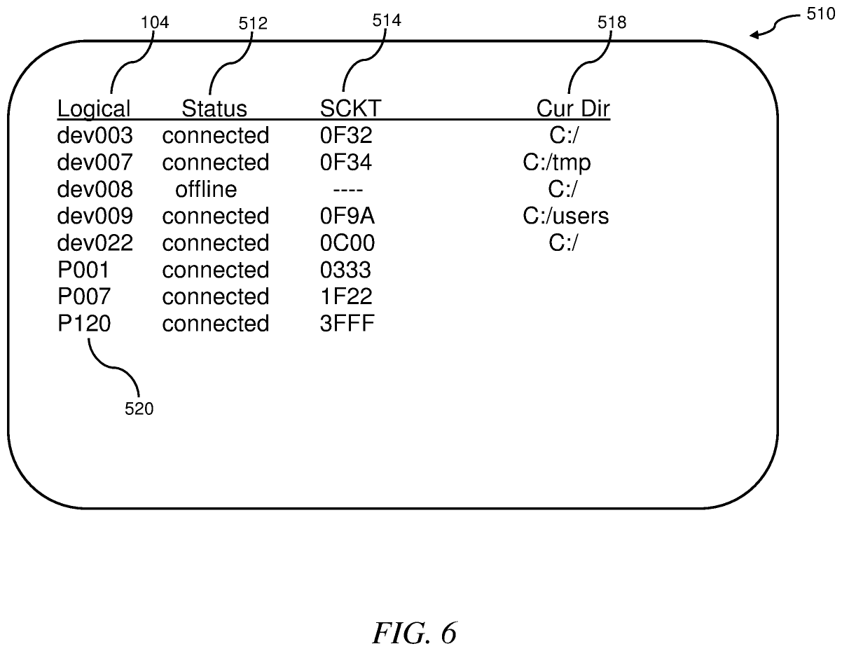

If the test 212 determines that the command 106 is a valid command, then an environment is setup 220 in which the standard output stream and the standard error stream is captured to a temporary storage and, in some embodiments, the current directory 508 (see FIG. 6) is set 222 to whatever directory the prior command set it to. In this, it is anticipated that, in such embodiments, the current directory 518 is maintained for each end-point device 12; either within the push controller module 16, within the web portal 10, or in a push database 510 (see FIG. 6) of the push server 500. In some embodiments, the current directory is maintained by the web portal computer 10. In such, it is anticipated that other events or commands will set the current directory, as needed.

Now the command 106 is executed 224 by the push controller module 16 and any output or error message from the command 106 being executed 224 winds up in the temporary storage. After the command 106 is executed 224, the text from the temporary storage (if any) is sent 226 to the push server 500 and the loop restarts. The push server 500 then forwards the text to the web portal computer 10.

Referring now to FIG. 6, an exemplary push database 510 of the push server 500 is shown. In this example, a list of logical addresses 104 includes each end-point device 12 that is connected or is anticipated to connect to the push server 500, along with a status 512 of each connection to the end-point devices 12, a connection socket 514 of the connection, and the current directory 518 for the end-point device 12, though in some embodiments, the web portal computer 10 tracks the current directory 518. Also shown in the push database 510 are three web portal devices 520 (P001, P007, and P120) along with a status 512 of each connection to the portal computers 10 and the associated connection socket 514. As command execution of commands on each end-point device 12 is asynchronous, it is anticipated that in a preferred embodiment, an identification of the web portal computer 10 that issued a command 106 is also sent to the push controller 16. In such, when the results from that command 106 are returned from the push controller 16, the push controller 16 includes the identification of the web portal computer 10 that issued a command 106 and the push server 500 uses the identification of the web portal computer 10 to route the output of the command to the originating web portal computer 10.

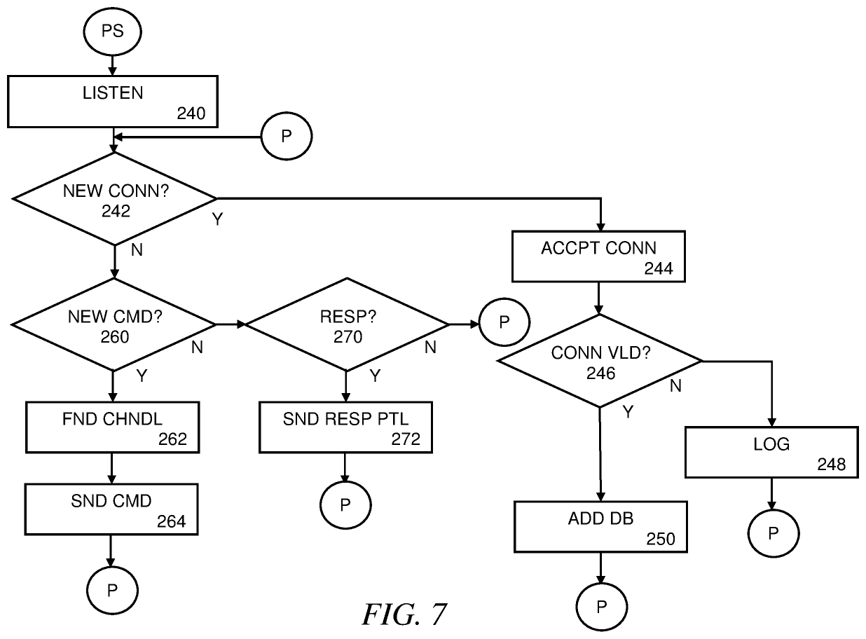

Referring to FIG. 7, an exemplary program flow of the push server 500 is shown. The push database 510 is initialized, for example, to include all logical addresses 104 that are anticipated to connect with the push server 500, all of which will have a status 512 of offline to begin, as no connections have been made as of yet. The push server 500 listens 240 for any connection activity (e.g. new connection, message received on an existing connection, a response). The push server looks for an incoming connection 242 from one of the end-point devices 12, a new command 260 received from one of the web portal computers 10, or a response back from one of the end-point devices 12. If an incoming connection 242 is detected, the connection is accepted 244 and a test is made to make sure the connection is valid 246. If the connection is not valid 246, an error is logged 248 and listening 240 restarts.

If the connection is valid 246, connection data is added to the push database 510 and the status 512 is updated to indicate a connection has been made, and the listening 240 restarts.

If a new command 260 is detected, the command 106 is parsed to extract the logical address 104 and the logical address 104 is used to index into the push database 510 to find 262 the connection handle (socket) 514 for that logical address 104 and the command part of the command 106 is sent 264 to the push controller module 16 at the other end of the connection, running on the end-point device 12. In some embodiments, an indication of which portal computer 10 initiated the command 106 is forwarded with the command 106 to the push control module 16 at the end-point device 12.

When a response is received 270 back from the push controller module 16, the push server sends the response 272 back to the web portal computer 10 that originated the command 106.

It is anticipated that there are timeout checks and error legs that are not shown for brevity reasons.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for remote computer command execution, the system comprising:
a push server;
a plurality of end-point device;
a push controller module installed on each of the end-point devices, each push controller module initializing upon start-up of a respective one of the end-point devices, and each push controller module automatically establishing a connection to the push server;
upon receiving a command for execution on one of the end-point devices from a web portal computer, the push server forwards the command to the push controller module of the one of the end-point devices over a respective one of the connections;
upon receiving the command, the push controller module executes the command on the end-point device, captures output from the command and forwards the output to the push server; and
upon receiving the output from the push controller module, the push server forwards the output to the web portal computer.

2. The system of claim 1, wherein the connection to the push server is by a web socket connection.

3. The system of claim 1, wherein the push controller module checks the command for validity before executing by searching for the command in a blacklist and preventing execution of the command if the command is found in the blacklist.

4. The system of claim 1, wherein the push controller module captures the output from standard output and standard error when the push controller module executes the command.

5. The system of claim 1, wherein the system for remote computer command execution keeps track of a current directory for each end-point device and sets the directory to the current directory before the push controller module executes the command.

6. A method of executing a command on a remote computer, the method comprising:
installing a push controller module on an end-point device;
upon initialization of the end-point device, running the push controller module;
establishing a connection to a push server by the push controller module;
upon receiving the command for the end-point device, the push server forwarding the command to the push controller module that is running on the end-point device; and
responsive to receiving the command, the push controller module executing the command.

7. The method of claim 6, further comprising:
during the step of executing the command, capturing an output of the command; and
sending the output of the command from the push controller module to the push server.

8. The method of claim 6, further comprising:
before the step of executing the command, setting a directory to a prior directory; and
after the step of executing the command, saving the directory as the prior directory.

9. The method of claim 6, further comprising:
before the step of executing the command, verifying that the command is allowed.

10. The method of claim 9, the step of verifying the command comprising:
looking for the command in a blacklist and if the command is in the blacklist, preventing the step of executing the command.

11. Program instructions tangibly embodied in a non-transitory storage medium comprising at least one instruction configured to implement a system for executing a command on a remote computer, wherein the at least one instruction comprises:
computer readable instructions executed by a processor of an end-point device causing the end-point device to initiate a connection to a push server;
computer readable instructions executed by a processor of the push server causing the server to accept the connection;
computer readable instructions executed by the processor of the push server receiving the command for the end-point device;
responsive to the computer readable instructions executed by the processor of the push server receiving the command, the computer readable instructions executed by the processor of the push server causing the server to forward the command to the computer readable instructions executed by the processor of the end-point device; and
responsive to receiving the command, the computer readable instructions executed by the processor of the end-point device causing the end-point device to execute the command.

12. The program instructions tangibly embodied in the non-transitory storage medium of claim 11, further comprising:
during the end-point device executing the command, the computer readable instructions executed by the processor of the end-point device causing the end-point device to capture output of the command; and
the computer readable instructions executed by the processor of the end-point device causing the end-point device to send the output to the push server.

13. The program instructions tangibly embodied in the non-transitory storage medium of claim 11, further comprising:
the computer readable instructions executed by the processor of the end-point device causing the end-point device to execute the command, the computer readable instructions executed by the processor of the end-point device causing the end-point device to set a directory to a prior directory; and
after the computer readable instructions executed by the processor of the end-point device causing the end-point device to execute the command, the computer readable instructions executed by the processor of the end-point device causing the end-point device to save the directory as the prior directory.

14. The program instructions tangibly embodied in the non-transitory storage medium of claim 11, further comprising:
before the computer readable instructions executed by the processor of the end-point device causing the end-point device to execute the command, the computer readable instructions executed by the processor of the end-point device causing the end-point device to verify that the command is allowed.

15. The program instructions tangibly embodied in the non-transitory storage medium of claim 14, wherein the end-point device verifies the command by:
the computer readable instructions executed by the processor of the end-point device causing the end-point device to look for the command in a blacklist and if the command is in the blacklist, the computer readable instructions executed by the processor of the end-point device causing the end-point device to prevent execution of the command.
